(19) United States
(12) Patent Application Publication
(10) Pub. No.: US 2026/0279679 A1
(43) Pub. Date: Sep. 17, 2026

(54) MULTILAYER ELECTRONIC COMPONENT

(71) Applicant: SAMSUNG ELECTRO-MECHANICS CO., LTD., Suwon-si (KR)

(72) Inventors: Jin Il Kang, Suwon-si (KR); Hyun Goo Jeong, Suwon-si (KR); Hong Gi Kim, Suwon-si (KR); Ji Won Lee, Suwon-si (KR); Chang Sik Park, Suwon-si (KR); Gyeong Hwan Yeo, Suwon-si (KR); Min Gi Song, Suwon-si (KR)

(73) Assignee: SAMSUNG ELECTRO-MECHANICS CO., LTD., Suwon-si (KR)

(21) Appl. No.: 19/463,844

(22) Filed: Jan. 29, 2026

(30) Foreign Application Priority Data
Mar. 13, 2025 (KR) 10-2025-0032758

(51) Int. Cl. H01G 4/30; H01G 4/012; H01G 4/232

(52) U.S. Cl. CPC H01G 4/30; H01G 4/012; H01G 4/2325

(57) ABSTRACT

A multilayer electronic component includes a body and an external electrode. The body includes a dielectric layer and an internal electrode alternately disposed with the dielectric layer. The external electrode includes a metal layer in contact with one end of the internal electrode, and an electrode layer disposed on the metal layer, the electrode layer including a conductive metal and glass. The body includes a groove portion in which the one end of the internal electrode is spaced apart from one surface of the body. The metal layer includes a first region disposed in the groove portion and a second region disposed on the one surface of the body. In a cross-section of the body, a length along which the first region and the one end of the internal electrode contact each other, is less than a length along which the first region and the second region contact each other.

### CROSS-REFERENCE TO RELATED APPLICATIONS

This application claims benefit of priority to Korean Patent Application No. 10-2025-0032758 filed on Mar. 13, 2025 in the Korean Intellectual Property Office, the disclosure of which is incorporated herein by reference in its entirety.

### TECHNICAL FIELD

The present disclosure relates to a multilayer electronic component.

A multilayer ceramic capacitor (MLCC), a multilayer electronic component, may be a chip-type condenser mounted on the printed circuit boards of various types of electronic products such as imaging devices, including a liquid crystal display (LCD) and a plasma display panel (PDP), computers, smartphones, and mobile phones, and may serve to charge or discharge electricity therein or therefrom.

The MLCC may be used as a component of various electronic devices due to having a small size, ensuring high capacitance and being easily mounted.

Recently, with the miniaturization and implementation of high performance of electronic devices, multilayer ceramic capacitors have also been tending toward miniaturization and high capacitance, and accordingly, the importance of securing high reliability of multilayer ceramic capacitors has been increasing.

In general, in order to reduce a thickness of an internal electrode, metal powder particles finer than those according to the related art may need to be used. However, when fine metal powder particles are used, a shrinkage initiation temperature may become a lower temperature, which may cause a difference in shrinkage behavior between an internal electrode and a dielectric layer. In this case, a shrinkage rate of the internal electrode may be greater than that of the dielectric layer, resulting in an issue in which connectivity between the internal electrode and an external electrode is reduced.

### SUMMARY

An aspect of the present disclosure is to provide a multilayer electronic component having excellent reliability.

Another aspect of the present disclosure is to suppress peeling and delamination of an external electrode.

Another aspect of the present disclosure is to reduce contact resistance between an internal electrode and an external electrode.

However, the aspects of the present disclosure are not limited to those set forth herein and will be more easily understood in the course of describing specific example embodiments of the present disclosure.

According to an aspect of the present disclosure, there is provided a multilayer electronic component including a body including a dielectric layer and an internal electrode alternately disposed with the dielectric layer, and an external electrode including a metal layer in contact with one end of the internal electrode, and a plating layer disposed on the metal layer. The body may include a groove portion in which the one end of the internal electrode is spaced apart from one surface of the body. The metal layer may include a first region disposed in the groove portion and a second region disposed on the one surface of the body. In a cross-section of the body, Lp1, a length along which the first region and the one end of the internal electrode are in contact with each other, may be less than Lp2, a length along which the first region and the second region are in contact with each other.

According to example embodiments of the present disclosure, a shape of a first region of a metal layer of an external electrode disposed in a groove portion of a body may be controlled, thereby improving reliability of a multilayer electronic component.

According to example embodiments of the present disclosure, peeling and delamination of an external electrode may be suppressed.

According to example embodiments of the present disclosure, contact resistance between an internal electrode and an external electrode may be reduced.

However, the various advantages and effects of the present disclosure are not limited to those set forth herein and will be more easily understood in the course of describing specific example embodiments of the present disclosure.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a schematic perspective view of a multilayer electronic component including a body according to an example embodiment of the present disclosure;

FIG. 2 is a schematic cross-sectional view taken along line I-I’ of FIG. 1;

FIG. 3 is a schematic cross-sectional view taken along line II-II’ of FIG. 1;

FIG. 4 is an exploded view of the body of FIG. 1;

FIG. 5 is an enlarged view of region K1 of FIG. 2, excluding an external electrode;

FIG. 6 is an enlarged view of region K1 of FIG. 2;

FIG. 7 is an image obtained by scanning a portion of a cross-section corresponding to K1 with a scanning electron microscope (SEM); and

FIG. 8 is a view corresponding to FIG. 2 according to another example embodiment of the present disclosure.

### DETAILED DESCRIPTION

Hereinafter, example embodiments of the present disclosure are described with reference to the accompanying drawings. The present disclosure may, however, be exemplified in many different forms and should not be construed as being limited to the specific example embodiments set forth herein. In addition, example embodiments of the present disclosure may be provided for a more complete description of the present disclosure to those skilled in the art. Accordingly, the shapes and sizes of the elements in the drawings may be exaggerated for clarity of description, and elements denoted by the same reference numerals in the drawings may be the same elements.

In order to clearly illustrate the present disclosure, portions not related to the description are omitted, and sizes and lengths are magnified in order to clearly represent layers and regions, and similar portions having the same functions within the same scope are denoted by similar reference numerals throughout the specification. Throughout the specification, when an element is referred to as “comprising” or “including,” it means that it may include other elements as well, rather than excluding other elements, unless specifically stated otherwise.

In the drawings, an X-direction may be defined as a first direction, a lamination direction, or a thickness (T) direction, a Y-direction may be defined as a second direction or a length (L) direction, and a Z-direction may be defined as a third direction or a width (W) direction.

### Multilayer Electronic Component

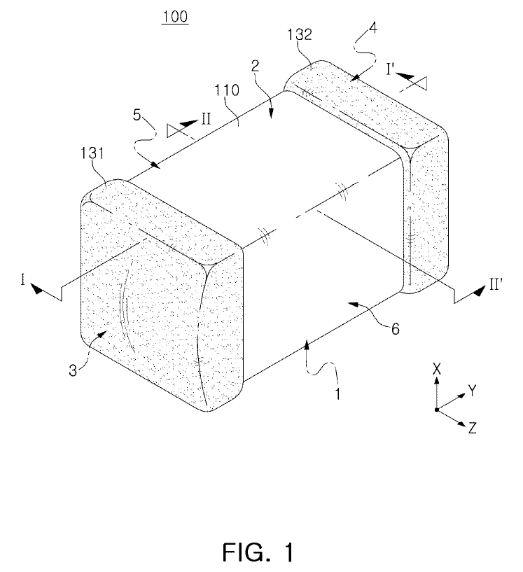

FIG. 1 is a schematic perspective view of a multilayer electronic component including a body according to an example embodiment of the present disclosure.

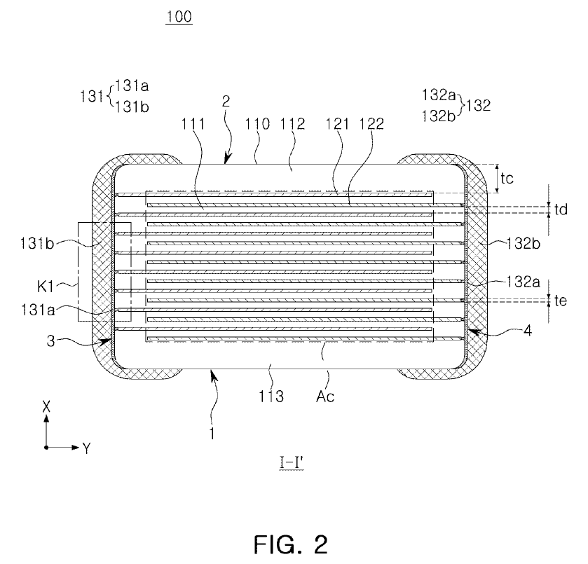

FIG. 2 is a schematic cross-sectional view taken along line I-I’ of FIG. 1.

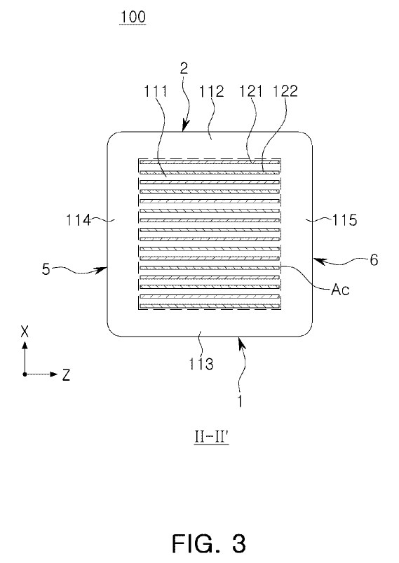

FIG. 3 is a schematic cross-sectional view taken along line II-II’ of FIG. 1.

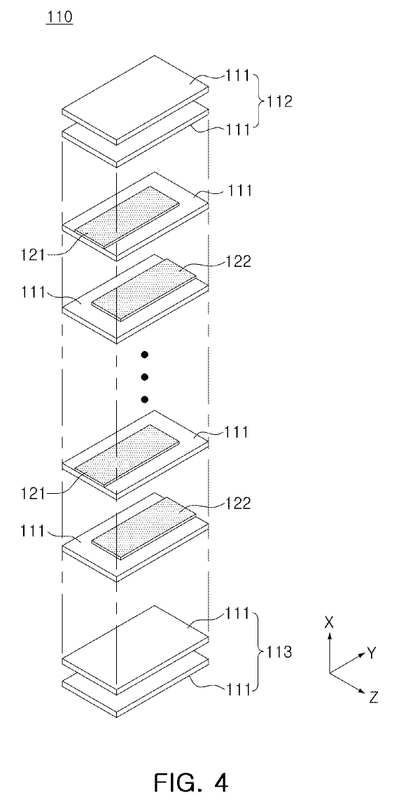

FIG. 4 is an exploded view of the body of FIG. 1.

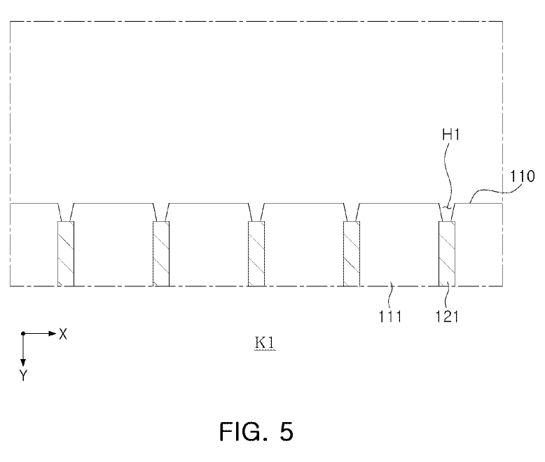

FIG. 5 is an enlarged view of region K1 of FIG. 2, excluding an external electrode.

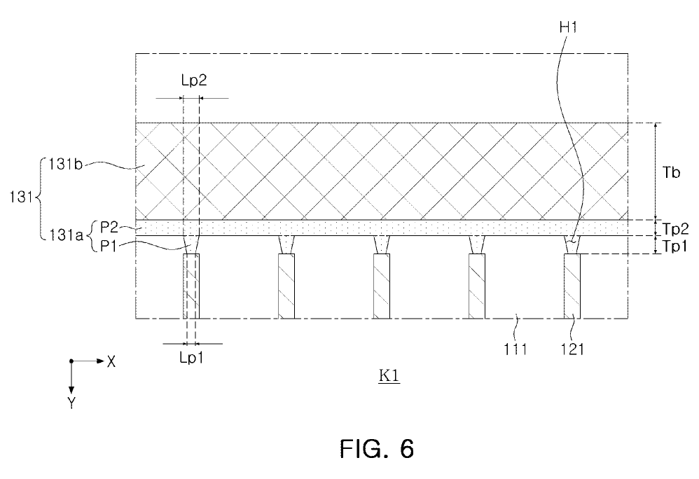

FIG. 6 is an enlarged view of region K1 of FIG. 2.

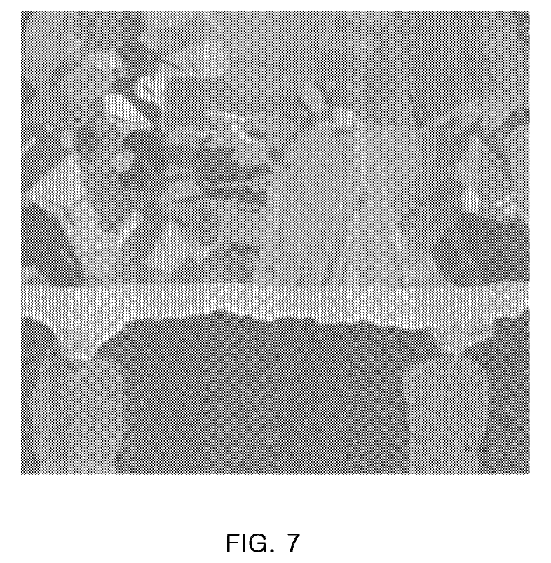

FIG. 7 is an image obtained by scanning a portion of a cross-section corresponding to K1 with a scanning electron microscope (SEM).

Hereinafter, a multilayer electronic component 100 according to an example embodiment of the present disclosure will be described in detail with reference to FIGS. 1-7. In addition, a multilayer ceramic capacitor (hereinafter referred to as “MLCC”) is described as an example of the multilayer electronic component, but the present disclosure is not limited thereto and may be applied to various electronic products formed of a ceramic material, for example, inductors, piezoelectric elements, varistors, thermistors, or the like.

A multilayer electronic component 100 according to an example embodiment of the present disclosure may include a body 110 and external electrodes 131 and 132. The body 110 may include a dielectric layer 111 and internal electrodes 121 and 122 alternately disposed with the dielectric layer 111.

The external electrode 131 may include a metal layer 131a. The external electrode 131 may be in contact with one end of at least one of the internal electrodes 121 and a plating layer 131b disposed on the metal layer 131a. The body 110 may include a groove portion H1 in which the one end of the internal electrode 121 is spaced apart from a third surface 3 of the body 110. The metal layer 131a may include a first region P1 disposed in the groove portion H1, and a second region P2 disposed on the third surface 3 of the body 110. In a cross-section of the body, Lp1, a length along which the first region P1 and the one end of the internal electrode 121 are in contact with each other, may be less than Lp2, a length along which the first region P1 and the second region P2 are in contact with each other.

The external electrode 132 may include a metal layer 132a. The external electrode 132 may be in contact with one end of at least one of the internal electrodes 122 and a plating layer 132b disposed on the metal layer 132a. The body 110 may include another groove portion H1 in which the one end of the internal electrode 122 is spaced apart from a fourth surface 4 of the body 110. The metal layer 132a may include a first region P1 disposed in the groove portion H1, and a second region P2 disposed on the fourth surface 4 of the body 110. In a cross-section of the body, Lp1, a length along which the first region P1 and the one end of the internal electrode 122 are in contact with each other, may be less than Lp2, a length along which the first region P1 and the second region P2 are in contact with each other.

FIG. 5 is an enlarged view of region K1 of FIG. 2, excluding the external electrodes 131 and 132. Referring to FIG. 5, the body 110 may include the groove portion H1 in which the one end of the internal electrode 121 is spaced apart from the third surface 3 of the body 110. The internal electrodes 121 and 122 and the dielectric layer 111 may be formed of different materials, such that a difference in shrinkage behavior may occur between the internal electrodes 121 and 122 and the dielectric layer 111 during sintering. Accordingly, the body 110 may include the groove portions H1 in which the one end of the internal electrode 121 is spaced apart from the third surface 3 of the body 110 and/or the one end of the internal electrode 122 is spaced apart from the fourth surface 4 of the body 110. The groove portion H1 may cause an issue in which connectivity between the internal electrodes 121 and 122 and the external electrodes 131 and 132 is lowered. In the related art, to resolve such an issue, an additional process of removing a protruding dielectric layer using a sand blast method or the like was used. In the present disclosure, the external electrodes 131 and 132 may include the metal layers 131a and 132a, and the metal layers 131a and 132a may include the first region P1 disposed in the groove portion and the second region P2 disposed on the third and fourth surfaces 3 and 4 of the body 110, respectively, thereby improving connectivity between the internal electrodes 121 and 122 and the external electrodes 131 and 132 without an additional polishing process.

In addition, the length Lp1 along which the first region P1 and the one end of the internal electrode 121, 122 are in contact with each other may be less than the length Lp2 along which the first region P1 and the second region P2 are in contact with each other, thereby suppressing peeling and delamination of the external electrodes 131 and 132 and reducing contact resistance between the internal electrodes 121 and 122 and the external electrodes 131 and 132.

Hereinafter, each of components included in the multilayer electronic component 100 according to an example embodiment of the present disclosure will be described.

In the body 110, the dielectric layer 111 and the internal electrodes 121 and 122 may be alternately laminated.

A specific shape of the body 110 is not limited. However, as illustrated, the body 110 may have a hexahedral shape or a shape similar thereto. During a sintering process, ceramic powder particles, included in the body 110 may shrink such that the body 110 may not have a hexahedral shape having perfectly straight lines, but may have a substantially hexahedral shape.

The body 110 may have first and second surfaces 1 and 2 opposing each other in a thickness direction, the third and fourth surfaces 3 and 4 connected to the first and second surfaces 1 and 2, the third and fourth surfaces 3 and 4 opposing each other in a length direction, and fifth and sixth surfaces 5 and 6 connected to the third and fourth surfaces 3 and 4, the fifth and sixth surfaces 5 and 6 opposing each other in a width direction.

As margin regions in which the internal electrodes 121 and 122 disposed on the dielectric layer 111 do not overlap each other, a step portion may be caused by thicknesses of the internal electrodes 121 and 122, such that a corner, connecting the first surface 1 and the third to fifth surfaces 3, 4, and 5 to each other, and/or a corner, connecting the second surface 2 and the third to fifth surfaces 3, 4, and 5 to each other, may shrink toward a central portion in a first direction of the body 110 relative to the first surface 1 or the second surface 2. Alternatively, due to shrinkage behavior of the body 110 during a sintering process, a corner, connecting the first surface 1 and the third to sixth surfaces 3, 4, 5, and 6 to each other, and/or a corner, connecting the second surface 2 and the third to sixth surfaces 3, 4, 5, and 6 to each other, may shrink toward the central portion in the thickness direction of the body 110 relative to the first surface 1 or the second surface 2. Alternatively, in order to prevent chipping defects or the like, an additional process may be performed to round corners connecting respective surfaces of the body 110 to each other. Accordingly, a corner, connecting the first surface 1 and third to sixth surfaces 3, 4, 5, and 6 to each other, and/or a corner, connecting the second surface 2 and the third to sixth surfaces 3, 4, 5, and 6 to each other, may have a rounded shape.

In order to suppress a step portion caused by the internal electrodes 121 and 122, the internal electrodes 121 and 122 may be laminated and then cut to be exposed to the fifth and sixth surfaces 5 and 6 of the body 110. Thereafter, one dielectric layer 111 or two or more dielectric layers 111 may be laminated on both side surfaces of a capacitance formation portion Ac in a third direction (width direction) to form margin portions 114 and 115. In this case, a portion, connecting the first surface 1 and the fifth and sixth surfaces 5 and 6 to each other, and a portion, connecting the second surface 2 and the fifth and sixth surfaces 5 and 6 to each other, may not shrink.

A plurality of dielectric layers 111 included in the body 110 may be in a sintered state, and adjacent dielectric layers 111 may be integrated with each other such that boundaries therebetween are not readily apparent without using a scanning electron microscope (SEM). The number of laminated dielectric layers is not limited and may be determined in consideration of a size of the multilayer electronic component. For example, the body 110 may be formed by laminating 400 or more dielectric layers 111.

The dielectric layer 111 may be formed by preparing a ceramic slurry including ceramic powder particles, an organic solvent, and a binder, coating the slurry on a carrier film and drying the same to prepare a ceramic green sheet, and then sintering the ceramic green sheet. The ceramic powder particles are not limited as long as sufficient capacitance is obtainable therewith, and may be, for example, barium titanate-based (BaTiO₃)-based powder particles. As a more specific example, the ceramic powder particles may be one or more selected from a group consisting of BaTiO₃, (Ba₁₋ₓCaₓ)TiO₃ (0<x<1), Ba(Ti_{1-y}Ca_{y})O3 (0<y<1), (Ba₁₋ₓCaₓ)(Ti_{1-y}Zr_{y})O₃ (0<x<1, 0<y<1) and Ba(Ti_{1-y}Zr_{y})O₃ (0<y<1).

In addition, an average thickness td of the dielectric layer 111 is not limited, but may be, for example, 0.01 μm to 10 μm. In addition, the average thickness td of the dielectric layer 111 may be arbitrarily set depending on desired characteristics or applications. For example, for small-sized IT electronic components, in order to achieve miniaturization and high capacitance, an average thickness td of at least one of the plurality of dielectric layers 111 may be 0.4 μm or less.

Here, the average thickness td of the dielectric layer 111 may refer to a size in the first direction of the dielectric layer 111 disposed between the internal electrodes 121 and 122. The average thickness td of the dielectric layer 111 may be measured, for example, by scanning, using an SEM, a cross-section in first and second directions of the body 110 at a magnification of 10,000X. More specifically, the average thickness td of the dielectric layer 111 may be measured by measuring thicknesses of one dielectric layer 111 at multiple points of the dielectric layer 111, for example, thirty points spaced apart from each other at equal intervals in the second direction, and calculating an average value of the thicknesses. The thirty points, spaced apart from each other at equal intervals, may be designated in the capacitance formation portion Ac. In addition, when such average value measurement is performed on ten dielectric layers 111, the average thickness td of the dielectric layer 111 may be further generalized.

The body 110 may include the capacitance formation portion Ac disposed in the body 110, the capacitance formation portion Ac having capacitance by including the first internal electrode 121 and the second internal electrode 122 disposed to oppose each other with the dielectric layer 111 interposed therebetween, and cover portions 112 and 113 disposed on upper and lower portions in the first direction of the capacitance formation portion Ac.

In addition, the capacitance formation portion Ac may be a portion contributing to forming capacitance of a capacitor and may be formed by repeatedly laminating a plurality of the first and second internal electrodes 121 and 122 on each other with the dielectric layer 111 interposed therebetween.

The cover portions 112 and 113 may include an upper cover portion 112 disposed on an upper portion in the thickness direction of the capacitance formation portion Ac, and a lower cover portion 113 disposed on a lower portion in the thickness direction of the capacitance formation portion Ac.

The upper cover portion 112 and the lower cover portion 113 may be respectively formed by laminating one dielectric layer 111 or two or more dielectric layers 111 on upper and lower surfaces of the capacitance formation portion Ac in the thickness direction and may basically serve to prevent the internal electrodes 121 and 122 from being damaged due to physical or chemical stress.

The upper cover portion 112 and the lower cover portion 113 may not include the internal electrodes 121 and 122 and may include a material the same as that of the dielectric layer 111.

That is, the upper cover portion 112 and the lower cover portion 113 may include a ceramic material, and may include, for example, a barium titanate (BaTiO₃)-based ceramic material.

A thickness of each of the cover portions 112 and 113 is not limited. However, in order to more easily achieve miniaturization and high capacitance of the multilayer electronic component, a thickness tc of each of the cover portions 112 and 113 may be 15 μm or less.

An average thickness tc of each of the cover portions 112 and 113 may refer to a size in the first direction of each of the cover portions 112 and 113, and may have a value obtained by averaging sizes of each of the cover portions 112 and 113 in the first direction, measured at five points, spaced apart from each other at equal intervals, of an upper portion or lower portion of the capacitance formation portion Ac.

In addition, the margin portions 114 and 115 may be disposed on side surfaces of the capacitance formation portion Ac, respectively.

The margin portions 114 and 115 may include a first margin portion 114 disposed on the fifth surface 5 of the body 110, and a second margin portion 115 disposed on the sixth surface 6 of the body 110. That is, the margin portions 114 and 115 may be disposed on both end surfaces in the width direction of the body 110, respectively.

As illustrated in FIG. 3, the margin portions 114 and 115 may refer to regions between both ends of each of the first and second internal electrodes 121 and 122 and a boundary surface of the body 110 in a cross-section of the body 110 cut in a width-thickness (W-T) direction.

The margin portions 114 and 115 may basically serve to prevent the internal electrodes 121 and 122 from being damaged due to physical or chemical stress.

The margin portions 114 and 115 may be formed by forming the internal electrodes 121 and 122 by coating a conductive paste on a ceramic green sheet, except for a portion of the ceramic green sheet on which a margin portion 114 or 115 is to be formed.

In addition, in order to suppress a step portion caused by the internal electrodes 121 and 122, the internal electrodes 121 and 122 may be laminated and then cut to be exposed to the fifth and sixth surfaces 5 and 6 of the body 110. Thereafter, one dielectric layer 111 or two or more dielectric layers 111 may be laminated on both side surfaces of the capacitance formation portion Ac in the third direction (width direction) to form the margin portions 114 and 115.

A width of each of the margin portions 114 and 115 is not limited. However, in order to more easily achieve miniaturization and high capacitance of the multilayer electronic component, an average width of each of the margin portions 114 and 115 may be 15 μm or less.

The average width of each of the margin portions 114 and 115 may be an average size in the third direction of a region in which the internal electrodes 121 and 122 are spaced apart from the fifth surface 5 or an average size in the third direction of a region in which the internal electrodes 121 and 122 are spaced apart from the sixth surface 6, and may have an average value of sizes in the third direction of each of the margin portions 114 and 115, measured at five points, spaced apart from each other at equal intervals, of a side surface of the capacitance formation portion Ac.

Accordingly, in an example embodiment, each of the average sizes in the third direction of the regions in which the internal electrodes 121 and 122 are spaced apart from the fifth and sixth surfaces 5 and 6 may be 15 μm or less.

The internal electrodes 121 and 122 may be alternately disposed with the dielectric layer 111. For example, a first internal electrode 121 and a second internal electrode 122, a pair of electrodes having different polarities, may be disposed to oppose each other with the dielectric layer 111 interposed therebetween. The first internal electrode 121 and the second internal electrode 122 may be electrically isolated from each other by the dielectric layer 111 interposed therebetween. In this case, the internal electrodes 121 and 122 may be alternately disposed with the dielectric layer 111 in the first direction.

The first internal electrode 121 may be spaced apart from the fourth surface 4 and may extend toward the third surface 3. The second internal electrode 122 may be spaced apart from the third surface 3 and may extend toward the fourth surface 4. The first internal electrode 121 may be electrically connected to the first external electrode 131 on the third surface 3, and the second internal electrode 122 may be electrically connected to the second external electrode 132 on the fourth surface 4.

A conductive metal included in the internal electrodes 121 and 122 may be one or more selected from a group consisting of Ni, Cu, Pd, Ag, Au, Pt, Sn, W, Ti, and alloys thereof, and may preferably include Ni, but the present disclosure is not limited thereto.

A method of forming the internal electrodes 121 and 122 is not limited. For example, the internal electrodes 121 and 122 may be formed by coating an internal electrode conductive paste including a conductive metal on a ceramic green sheet and sintering the same. A screen-printing method or a gravure-printing method may be used as a method of coating the internal electrode conductive paste, but the present disclosure is not limited thereto.

An average thickness te of each of the internal electrodes 121 and 122 is not limited, but may be, for example, 0.01 μm to 3 μm. In addition, the average thickness te of each of the internal electrodes 121 and 122 may be arbitrarily set depending on desired characteristics or applications. For example, for small-sized IT electronic components, in order to achieve miniaturization and high capacitance, an average thickness te of at least one of a plurality of internal electrodes 121 and 122 may be 0.4 μm or less.

Here, the average thickness te of the internal electrodes 121 and 122 may be measured by scanning, using an SEM, the cross-section of the body 110 in the first and second directions at a magnification of 10,000X. More specifically, thicknesses of each of the internal electrodes 121 and 122 at multiple points, for example, thirty points spaced apart from each other at equal intervals in the second direction, may be measured to measure an average value thereof. The thirty points, spaced apart from each other at equal intervals, may be designated in the capacitance formation portion Ac. In addition, when such average value measurement is performed on ten internal electrodes 121 or ten internal electrodes 122, the average thickness of each of the internal electrodes 121 and 122 may be further generalized.

The external electrodes 131 and 132 may include the metal layers 131a and 132a in contact with the one end of the internal electrodes 121 and 122, respectively, and the plating layers 131b and 132b disposed on the metal layers 131a and 132a, respectively.

The body 110 may include a groove portion H1 in which the one end of the internal electrode 121 is spaced apart from the third surface 3 of the body 110 and the internal electrode 122 is spaced apart from the fourth surface 4 of the body 110. The metal layer 131a may include a first region P1 disposed in the groove portion H1 and a second region P2 disposed on the third surface 3 of the body 110. Similarly, the body 110 may include the groove portion H1 in which the one end of the internal electrode 122 is spaced apart from the fourth surface 4 of the body 110. The metal layer 132a may include a first region P1 disposed in the groove portion H1 and a second region P2 disposed on the fourth surface 4 of the body 110.

As illustrated in FIG. 2, the external electrodes 131 and 132 may include a first external electrode 131 disposed on the third surface 3, the first external electrode 131 connected to the first internal electrode 121, and a second external electrode 132 disposed on the fourth surface 4, the second external electrode 132 connected to the second internal electrode 122.

In the present example embodiment, a structure in which the multilayer electronic component 100 has two external electrodes 131 and 132 is described, but the number and shape of the external electrodes 131 and 132 may be changed depending on the form of the internal electrodes 121 and 122 or other purposes.

FIG. 6 is an enlarged view of region K1 of FIG. 2. Region K1 illustrates an enlarged portion of a portion on which the first external electrode 131 is disposed. The first external electrode 131 may be different from the second external electrode 132 in that the first external electrode 131 is disposed on the third surface 3 and the second external electrode 132 is disposed on the fourth surface 4. However, the first external electrode 131 and the second external electrode 132 may be the same in terms of a configuration. The following description is provided based on the first external electrode 131, which is considered to include the description related to the second external electrode 132.

The metal layers 131a and 132a may each include the first region P1 disposed in the groove portion H1, and the second region P2 disposed on the third or fourth surface 3 or 4 of the body 110. In the cross-section of the body 110, the average length Lp1 along which the first region P1 and the one end of the at least one of the internal electrodes 121 or the at least one of the internal electrodes 122 are in contact with each other may be less than an average length Lp2 along which the first region P1 and the second region P2 are in contact with each other. In this case, the cross-section of the body 110 may be a cross-section in the length direction and the thickness direction of the body 110.

As Lp1 < Lp2 is satisfied, a contact area between the first region P1 and the second region P2 may be increased, thereby improving interfacial adhesion and effectively dispersing stress at an interface between the first region P1 and the second region P2 when temperature changes or mechanical stress is applied.

In addition, as Lp1 < Lp2 is satisfied, the first region P1 may have an inverted trapezoidal shape in the cross-section of the body 110, which may result from the groove portion H1 having an inverted trapezoidal shape and the first region P1 being formed in the groove portion H1. As the first region P1 has an inverted trapezoidal shape, the contact area between the first region P1 and the second region P2 may be increased, thereby improving interfacial adhesion and effectively dispersing stress at the interface when temperature changes or mechanical stress is applied. In addition, as the first region P1 has an inverted trapezoidal shape, the first region P1 may serve to gradually disperse current flow between the internal electrodes 121 and 122 and the external electrodes 131 and 132, thereby reducing current crowding and consequently lowering contact resistance.

Conversely, when Lp1 is equal to Lp2 and the first region P1 has a rectangular shape, the contact area may decrease. Due to a simple planar structure, peeling and delamination of the external electrodes 131 and 132 may occur at an interface between the internal electrodes 121 and 122 and the external electrodes 131 and 132. In addition, when the first region P1 has a rectangular shape, current crowding may occur in a specific region when the first region P1 is formed using a sputtering process, which may cause a local increase in electrical resistance.

In addition, when the metal layers 131a and 132a are formed using a sputtering process, the groove portion H1 may have a rectangular shape. In this case, sputtered metal may not be properly deposited on a sidewall portion of the groove portion H1, and thus the metal layers 131a and 132a may be non-uniformly formed. Conversely, when the groove portion H1 has an inverted trapezoidal shape, a sidewall of the groove portion H1 may be gentle, such that deposition of the sputtered metal may be facilitated, and the metal layers 131a and 132a may be more uniformly formed.

A method of controlling shapes of the first region P1 and the groove portion H1 is not limited. For example, the shape of the groove portion H1 may be controlled by adjusting a difference in shrinkage behavior between the internal electrodes 121 and 122 and the dielectric layer 111 during sintering, and the shape of the first region P1 may be determined depending on the shape of the groove portion H1.

In an example embodiment, an average length Lp1 along which the first region P1 and the one end of the internal electrode 121, 122 are in contact with each other may be less than an average thickness of the one end of the internal electrode 121, 122, which may result from the groove portion H1 being formed in an inverted trapezoidal shape. Here, the thickness of the one end of the internal electrode 121, 122 may refer to a size in an X-direction of the internal electrodes 121 and 122.

A ratio between Lp1 and Lp2 is not limited. For example, a ratio of Lp2 to Lp1, Lp2/Lp1, may be 1.2 or more and 3.5 or less.

In an example embodiment, Tp2, an average thickness of the second region P2, may be 200 nm or more and 300 nm or less. Accordingly, a uniform conductive path may be secured, thereby further improving electrical connectivity between the internal electrodes 121 and 122 and the external electrodes 131 and 132. In addition, sufficient bonding strength between the metal layers 131a and 132a and the plating layers 131b and 132b may be secured.

When the average thickness of the second region P2 is too small, it may be difficult to secure a uniform conductive path, and electrical conductivity may be reduced, and it may be difficult to uniformly grow the plating layer. Conversely, when the average thickness of the second region P2 is too large, thermal stress may increase, which may cause a possibility of delamination at the interface and the occurrence of cracks or the like.

An average thickness of the first region P1 is not limited. For example, Tp1, the average thickness of the first region P1, may be 100 nm or more and 500 nm or less.

In addition, an average thickness of each of the plating layers 131b and 132b is not limited. For example, Tb, an average thickness of each of the plating layers 131b and 132b, may be 3 μm or more and 20 μm or less.

Lp1, Lp2, Tp1, Tp2, Tb, and the average thickness of the one end of the internal electrodes 121 and 122 may be obtained by measuring a cross-section in the length direction and thickness direction (L-T cross-section) of a central portion in the width direction of the multilayer electronic component 100, as illustrated in FIG. 6. Lp1, Lp2, and Tp1 may each be an average value obtained by averaging values measured from five first regions P1. The average thickness of the one end of the internal electrodes 121 and 122 may be an average value of thicknesses of an end of the internal electrodes 121 and 122 in contact with the five first regions P1. In addition, Tp2 may be an average value of thicknesses of the second region P2 measured at five points spaced apart from each other at equal intervals in the thickness direction, and Tb may be an average value of thicknesses of the plating layers 131b and 132b measured at five points spaced apart from each other at equal intervals in the thickness direction.

The metal layers 131a and 132a may be sputtered layers formed using a sputtering process. When the metal layers 131a and 132a are formed using a plating process, the first region P1 may not be sufficiently formed in the groove portion H1, and thus electrical connectivity between the internal electrodes 121 and 122 and the external electrodes 131 and 132 may not be sufficiently secured. Conversely, when the sputtering process is used, the metal layers 131a and 132a may be uniformly deposited in the groove portion H1, and the metal layers 131a and 132a may serve as seed layers for forming the plating layers 131b and 132b, thereby maximizing electrical connectivity between the internal electrodes 121 and 122 and the external electrodes 131 and 132.

In an example embodiment, the metal layers 131a and 132a may include one or more selected from a group consisting of Ni, Ti, and Au.

In an example embodiment, the plating layers 131b and 132b may be Cu plating layers, but the present disclosure is not limited thereto. The plating layers 131b and 132b may include Cu, Ni, Sn, Pd, and/or an alloy including Cu, Ni, Sn, or Pd, and may be formed of a plurality of layers. For example, the plating layers 131b and 132b may have a structure in which a Cu plating layer, a Ni plating layer, and a Sn plating layer are sequentially formed.

In an example embodiment, the metal layers 131a and 132a and the plating layers 131b and 132b may have different crystal structures.

As the metal layers 131a and 132a are formed using the sputtering process, the metal layers 131a and 132a may have an amorphous structure or a fine and uniform crystal grain structure having a size from several nanometers to several hundreds of nanometers.

The plating layers 131b and 132b may be formed using an electroplating process. Electroplating may be a wet process in which metal ions are deposited through an electrode reaction in a solution, and a grain size of each of the plating layers 131b and 132b may generally range from several hundred nanometers to micrometers.

In an example embodiment, the metal layers 131a and 132a have an amorphous structure, and the plating layers 131b and 132b may have a polycrystalline structure.

In an example embodiment, an average grain size of the metal layers 131a and 132a may be less than an average grain size of the plating layers 131b and 132b.

In an example embodiment, the average grain size of each of the metal layers 131a and 132a may be 50 nm or less, and the average grain size of each of the plating layers 131b and 132b may be 100 nm or more.

FIG. 7 is an image obtained by scanning a part of a cross section corresponding to K1 with a scanning electron microscope (SEM). Referring to FIG. 7, it may be confirmed that a metal layer has a fine and uniform grain structure, and a plating layer includes a plurality of grains having a large grain size.

In an example embodiment, the internal electrodes 121 and 122 may include a first internal electrode 121 and a second internal electrode 122 alternately disposed in a thickness direction with the dielectric layer interposed therebetween. The body 110 may include first and second surfaces 1 and 2 opposing each other in the thickness direction, third and fourth surfaces 3 and 4 connected to the first and second surfaces 1 and 2, the third and fourth surfaces 3 and 4 opposing each other in a length direction, and fifth and sixth surfaces 5 and 6 connected to the first through fourth surfaces, the fifth and sixth surfaces 5 and 6 opposing each other in a width direction. The external electrodes 131 and 132 may include a first external electrode 131 disposed on the third surface 3, the first external electrode 131 connected to the first internal electrode 121, and a second external electrode 132 disposed on the fourth surface 4, the second external electrode 132 connected to the second internal electrode 122.

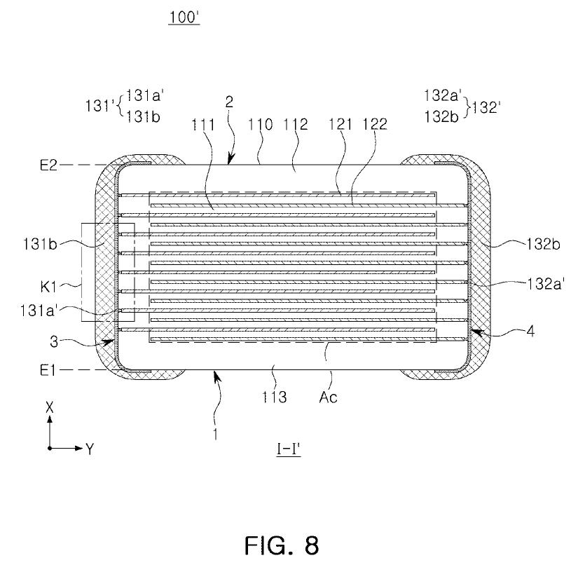

FIG. 8 is a view corresponding to FIG. 2 of a multilayer electronic component 100’ according to another example embodiment of the present disclosure. It should be understood that unless otherwise noted, components illustrated in FIG. 8 and their reference number correspond with description above with respect to the multilayer electronic component 100.

Referring to FIG. 8, metal layers 131a’ and 132a’ may be disposed to extend to at least a portion of the first and second surfaces 1 and 2. A first metal layer 131a’ may cover the third surface 3 and may be disposed to extend to at least a portion of the first and second surfaces 1 and 2 beyond an extension line E1 of the first surface 1 and an extension line E2 of the second surface 2. A second metal layer 132a’ may cover the fourth surface 4 and may be disposed to extend to at least a portion of the first and second surfaces 1 and 2 beyond the extension line E1 of the first surface 1 and the extension line E2 of the second surface 2.

In this case, as the metal layers 131a’ and 132a’ may extend onto portions of the first and second surfaces 1 and 2, and thus may cover corners of the body 110, thereby easily securing a sufficient thickness of each of the external electrodes 131’ and 132’ at the corners of the body 110 and improving moisture resistance reliability.

While example embodiments have been shown and described above, it will be apparent to those skilled in the art that modifications and variations could be made without departing from the scope of the present disclosure as defined by the appended claims.

In addition, the term “an example embodiment” used herein does not refer to the same example embodiment and is provided to emphasize a particular feature or characteristic different from that of another example embodiment. However, example embodiments provided herein are considered to be able to be implemented by being combined in whole or in part one with one another. For example, one element described in a particular example embodiment, even if it is not described in another example embodiment, may be understood as a description related to another example embodiment, unless an opposite or contradictory description is provided therein.

The terms used herein are for the purpose of describing particular example embodiments only and are to not be limiting of the example embodiments. As used herein, the singular forms “a,” “an,” and “the” are intended to include the plural forms as well, unless the context clearly indicates otherwise.

Here and throughout the specification and claims, range limitations are combined and/or interchanged. Such ranges are identified and include all the sub-ranges contained therein unless context or language indicates otherwise. For example, all ranges disclosed herein are inclusive of the endpoints, and the endpoints are independently combinable with each other.

Approximating language, as used herein throughout the specification and claims, may be applied to modify any quantitative representation that could permissibly vary without resulting in a change in the basic function to which it is related. Accordingly, a value solidified by a term or terms, such as “about”, and “substantially” is not to be limited to the precise value specified.

What is claimed is:

1. A multilayer electronic component comprising:
a body including a dielectric layer and an internal electrode alternately disposed with the dielectric layer; and
an external electrode including a metal layer in contact with one end of the internal electrode, and a plating layer disposed on the metal layer,
wherein the body includes a groove portion in which the one end of the internal electrode is spaced apart from one surface of the body, and the metal layer includes a first region disposed in the groove portion and a second region disposed on the one surface of the body, and
in a cross-section of the body, Lp1, a length along which the first region and the one end of the internal electrode are in contact with each other, is less than Lp2, a length along which the first region and the second region are in contact with each other.

2. The multilayer electronic component of claim 1, wherein, in the cross-section of the body, the first region has an inverted trapezoidal shape.

3. The multilayer electronic component of claim 1, wherein Lp1 is less than a thickness of the one end of the internal electrode.

4. The multilayer electronic component of claim 1, wherein a ratio of Lp2 to Lp1 is 1.2 or more and 3.5 or less.

5. The multilayer electronic component of claim 1, wherein Tp2, an average thickness of the second region, is 200 nm or more and 300 nm or less.

6. The multilayer electronic component of claim 1, wherein Tp1, an average thickness of the first region, is 100 nm or more and 500 nm or less.

7. The multilayer electronic component of claim 1, wherein the plating layer is a Cu plating layer.

8. The multilayer electronic component of claim 1, wherein the metal layer includes one or more selected from a group consisting of Ni, Ti, and Au.

9. The multilayer electronic component of claim 1, wherein the metal layer and the plating layer have different crystal structures.

10. The multilayer electronic component of claim 1, wherein
the metal layer has an amorphous structure, and
the plating layer has a polycrystalline structure.

11. The multilayer electronic component of claim 1, wherein an average grain size of the metal layer is less than an average grain size of the plating layer.

12. The multilayer electronic component of claim 1, wherein
an average grain size of the metal layer is 50 nm or less, and
an average grain size of the plating layer is 100 nm or more.

13. The multilayer electronic component of claim 1, wherein
the internal electrode includes a first internal electrode and a second internal electrode alternately disposed in a thickness direction with the dielectric layer interposed therebetween,
the body includes first and second surfaces opposing each other in the thickness direction, third and fourth surfaces connected to the first and second surfaces, the third and fourth surfaces opposing each other in a length direction, and fifth and sixth surfaces connected to the first to fourth surfaces, the fifth and sixth surfaces opposing each other in a width direction, and
the external electrode includes a first external electrode disposed on the third surface, the first external electrode connected to the first internal electrode, and a second external electrode disposed on the fourth surface, the second external electrode connected to the second internal electrode.

14. The multilayer electronic component of claim 13, wherein the cross-section of the body is a cross-section in the length direction and the thickness direction of the body.

15. The multilayer electronic component of claim 13, wherein the metal layer is disposed to extend to at least a portion of the first and second surfaces.
